(19) United States
(12) Patent Application Publication
(10) Pub. No.: US 2015/0109657 A1
(43) Pub. Date: Apr. 23, 2015

(54) Composite Optical Materials for Mechanical Deformation

(71) Applicants: Cambridge Enterprise Limited, Cambridge (GB); Fraunhofer-Gesellschaft zur Forderung der Angewandten Forschung e. V., München (DE)

(72) Inventors: Jeremy John Baumberg, Cambridge (GB); David Robert Evan Snoswell, Cambridge (GB); Andreas Kontogeorgos, Patras (GR); Götz Peter Hellmann, Darmstadt (DE); Peter Wolfgang Andreas Spahn, Hanau (DE)

(21) Appl. No.: 14/360,733

(22) PCT Filed: Nov. 30, 2012
(86) PCT No.: PCT/GB2012/052958

§ 371 Date: May 27, 2014

(30) Foreign Application Priority Data
Nov. 30, 2011 (GB) 1120648.9

(51) Int. Cl. G02F 1/01; B32B 37/18

(52) U.S. Cl. CPC G02F 1/0131; B32B 37/18
USPC 359/291; 156/60

(57) ABSTRACT

A composite optical device has a layer of a composite optical material mounted on a substrate. The layer of composite optical material has substantially uniform thickness. The composite optical material is a polymer opal, in that it has a three dimensional arrangement of core particles distributed in a matrix, the refractive index of the material of the core particles being different to the refractive index of the material of the matrix and the three dimensional arrangement being capable of having a periodicity such that, when a surface of the material is illuminated with white light, the composite material exhibits structural colour. The local stiffness of the substrate is different at different positions of the substrate. The effect of this is that, on mechanical deformation of the composite optical device, the substrate is deformed to a different extent at different positions of the substrate and the layer of composite optical material is correspondingly deformed to a different extent at different positions of the layer of composite optical material. This provides local variation in the structural colour response of the layer of composite optical material on mechanical deformation of the composite optical device.

### BACKGROUND TO THE INVENTION

1. Field of the Invention

The present invention relates to composite optical materials which demonstrate structural colour characteristics which vary depending on mechanical deformation, uses of such composite optical materials and to methods of manufacturing such composite optical materials. Of particular, but not exclusive, interest is the provision of variation in structural colour characteristics on stretching and/or bending.

2. Related Art

Many security features of bank notes, passports, credit cards, brand labels and other documents are based on special colour features. Of special interest are dynamic colours which change when the security feature is changed in orientation with respect to the viewer's eye. Natural opal shows such colours.

Natural opal is built up from domains consisting of monodisperse silica spheres of diameter 150-400 nm. These spheres are close-packed and therefore form a regular three dimensional lattice structure within each domain. The colour play of such opals is created by Bragg-like scattering of the incident light at the lattice planes of the domains.

It is known to produce synthetic opal-like materials. For example, U.S. Pat. No. 4,703,020 discloses the formation of such materials by allowing silica spheres to sediment from an aqueous dispersion. This sediment is then dried and calcined at 800° C. Subsequently, a solution of zirconium alkoxide is allowed to penetrate into the interstices in the sediment and zirconium oxide is precipitated in the interstices by hydrolysis. The material is then calcined again to leave a structure in which silica spheres are arranged in a three dimensional lattice with zirconium oxide in the interstices. Forming opal-like materials in this way is exceptionally time-consuming and expensive. It is not an industrially-applicable route for the manufacture of significant quantities of materials.

US 2004/0253443 (equivalent to WO03025035) discloses moulded bodies formed from core-shell particles. Each particle is formed of a solid core, and the solid cores have a monodisperse particle size distribution. Each particle has a shell formed surrounding the core. The core and shell have different refractive indices. In one embodiment in this document, the core is formed of crosslinked polystyrene and the shell is formed of a polyacrylate such as polymethyl methacrylate (PMMA). In this case, the core has a relatively high refractive index and the shell has a relatively low refractive index. A polymer interlayer may be provided between the core and shell, in order to adhere the shell to the core. Granules of the core-shell particles are heated and pressed to give a film. In this heating and pressing step shell material is soft but the core material remains solid. The cores form a three dimensional periodic lattice arrangement (fcc arrangement), and the shell material becomes a matrix material. The resultant composite material demonstrates an optical opalescent effect. US 2004/0253443 suggests mechanisms to explain the ordering of the core particles in the matrix, but these are not fully explained. The composite material is referred to in some circumstances as a “polymer opal”.

WO2004096894 provides similar disclosure to US 2004/0253443, and additionally proposes extruding the composite material as a sheet and subsequently rolling the material. The result is reported to be a uniform colour effect, the colour seen being dependent on the viewing angle.

Different approaches have been disclosed to produce polymer films with an internal opaline structure. Asher et al (1994) [S. A. Asher, J. Holtz, L. Liu, Z. Wu “Self-Assembly Motif for Creating Submicron Periodic Materials, Polymerized Crystalline Colloidal Arrays” J. Am. Chem. Soc. 1994, 116, 4997-4998] disclosed the synthesis and possible applications of opal gels where monodispersed, charged polymer beads were crystallized in suspension and the dispersing liquid was subsequently crosslinked. Kumacheva et al (1999) [0. Kalinina, E. Kumacheva “A “Core-Shell” Approach to Producing 3D Polymer Nanocomposites” Macromol 1999, 32, 4122-4129] disclosed opaline coatings made by the drying of aqueous suspensions of core-shell polymer beads and the subsequent heating of the coating until the shells flowed and formed a continuous matrix. A similar approach is described in U.S. Pat. No. 6,337,131 (equivalent to EP-A-955323). Jethmalani and Ford (1996) [J. M. Jethmalani, W. T. Ford “Diffraction of Visible Light by Ordered Monodisperse Silica-Poly(methyl acrylate) Composite Films” Chem. Mater. 1996, 8, 2138-2146] describe the preparation of colloidal crystals of silica beads embedded in poly methylmethacrylate films. Crystals of silica beads embedded in polymer films were also used to prepare polymer films with crystalline lattices of pores (the so-called inverse opals) as described by Arsenault et al (2006) [A. C. Arsenault, T. J. Clark, G. von Freymann, L. Cademartiri, R. Sapienza, J. Bertalotti, E. Vekris, S. Wong, V. Kitaev, I. Manners, R. Z. Wang, S. John, D. Wiersma, G. A. Ozin “From colour fingerprinting to the control of photoluminescence in elastic photonic crystals” Nat Mater 2006, 5, 179-184] and Jiang et al (2004) [P. Jiang, M. J. McFarland “Large-Scale Fabrication of Wafer-Size Colloidal Crystals, Macroporous Polymers and Nanocomposites by Spin-Coating” J. Am. Chem. Soc. 2004, 126, 50 13778-13786]. Jiang et al (2004) used a spin-coating technique for the preparation of the colloidal crystalline silica-polymer precursor films.

An advantage of the colloidal crystal films with continuous polymeric matrices is their deformability. Unlike in a suspension, deformation of a polymeric opal structure leads to a distortion of the whole lattice of the crystal. Depending on the kind and elasticity of the polymer, the deformation can be large and reversible. Strain induced colour changes have been observed and described in the following literature:
Jethmalani and Ford (1996)
Ruhl and Hellman (2001) [T. Ruhl, G. P. Hellmann “Colloidal Crystals in Latex Films: Rubbery Opals” Macromol. Chem. Phys. 2001, 202, 3502-3505]
Viel at al (2007) [B. Viel, T. Ruhl, G. P. Hellmann “Reversible Deformation of Opal Elastomers” Chem. Mater. 2007, 19, 5673-5679;]
Pursiainen et al (2005) [0. L. J. Pursiainen, J. J. Baumberg, K. Ryan, J. Bauer, H.
Winkler, B. Viel, T. Ruhl “Compact strain-sensitive flexible photonic crystals for sensors” Appl. Phys. Lett. 2005, 87, 101902] Arsenault et al (2006)
Wohlleben et al (2007) [W. Wohlleben, F. W. Bartels, S. Altmann, R. J. Leyrer “Mechano-Optical Octave-Tunable Elastic Colloidal Crystals Made from Core-Shell Polymer Beads with Self Assembly Techniques” Langmuir 2007, 23, 2961-2969]
Ying and Foulger (2009) [Y. Ying, S. H. Foulger “Color characteristics of mechanochromic photonic bandgap composites” Sensors and Actuators B 2009, 574-577]

Academic and industrial interest has focused on the colour of the surface-parallel crystal planes (the (111) set of planes of the fcc lattice) because these planes provide the most intense structural colour from the polymer opal. With increasing strain, the wavelength of their reflection colour decreases and simultaneously its intensity decreases as well. At a high strain of about 60% or more, only a weak bluish-grey shade remains. The decrease of the wavelength under strain is considered to be due to the decrease in film thickness which leads to a decrease of the distance of the surface-parallel planes of the crystal lattice.

US 2009/0012207 discloses the use of core-shell particles to form a layer of polymer opal. The layer is applied to medical or hygiene articles. When strained, the reflected colour changes due to changes in the lattice spacing in the material. This therefore gives the user an indication of when the medical or hygiene article is stretched too tightly. There is disclosure of the possibility of crosslinking the matrix, for example using thermal or photochemical initiation of a crosslinking reaction of a crosslinking reagent in the matrix.

EP-B-2054241 discloses the manufacture of security features for banknotes etc. in which a polymer opal film is subjected to an external stimulus (e.g. mechanical stretching) in order to change the structural colour exhibited by the security feature. EP-B-2054241 suggests providing local variations in the mechanical properties of the polymer opal film. This results in a corresponding variation in the mechanical response of different areas of the film, leading to variation in the lattice spacing between the crystal planes at different areas of the film. This in turn leads to a local variation in the structural colour response of the polymer opal film. Suitable variation in mechanical properties can apparently be provided by varying the cross-linking density in the polymer opal film. In an alternative embodiment in EP-B-2054241, a similar effect is suggested by varying the local thickness of the polymer opal film.

### SUMMARY OF THE INVENTION

The present inventors consider that it is of interest to further develop composite optical materials in order to provide a composite optical material in which the structural colour exhibited varies on deformation. This is of particular, but not exclusive, interest in the formation of security features for documents of value such as bank notes, passports, credit cards, brand labels and other documents.

The present invention has been devised in order to address the want of such a composite optical material. Further advantages, and/or problems that may be solved by the present invention, are set out in more detail below.

The disclosure of EP-B-2054241 relevant to local variation in structural colour response on mechanical deformation of the polymer opal film concentrates on local control of the stiffness of the polymer opal film, whether by control of the local cross linking density of the polymer opal film or by control of the local thickness of the polymer opal film. However, the present inventors have realised that the range of variation in local stiffness of the polymer opal film is relatively narrow. In turn, this gives only a relatively narrow variation in local structural colour response. Furthermore, it is considered that typically the maximum stiffness that can be achieved in the polymer opal is limited. If over-crosslinked, the opal becomes brittle and can crack, losing flexibility and durability. In the opinion of the inventors, one major drawback of the approach in EP-B-2054241 is that the opal film must provide not only the non-optical properties like mechanical strength and durability but also the optical properties. This makes it very difficult to adjust the film to meet requirements for certain applications because it is typically of importance for most applications that the colour should not be impaired. The inventors consider that it is not possible to change e.g. the mechanical strength by a variation of the chemical composition without considering the impact on the process of self-assembly or on the refractive index contrast of the polymer opal film.

The present invention is based on the realisation by the inventors that control of the local deformation of a polymer opal film can be given by control of the local stiffness of a substrate with respect to which the polymer opal film is mounted. This represents a general aspect of the invention.

Accordingly, in a first preferred aspect, the present invention provides a composite optical device in which a layer of a composite optical material is mounted with respect to a substrate, the layer of composite optical material having substantially uniform thickness, and wherein the composite optical material has a three dimensional arrangement of core particles distributed in a matrix, the refractive index of the material of the core particles being different to the refractive index of the material of the matrix and the three dimensional arrangement being capable of having a periodicity such that, when a surface of the material is illuminated with white light, the composite material exhibits structural colour,
wherein the local stiffness of the substrate is different at different positions of the substrate, so that on mechanical deformation of the composite optical device, the substrate is deformed to a different extent at different positions of the substrate and the layer of composite optical material is correspondingly deformed to a different extent at different positions of the layer of composite optical material, thereby providing local variation in the structural colour response of the layer of composite optical material on mechanical deformation of the composite optical device.

In a second preferred aspect, the present invention provides a method for manufacturing a composite optical device, the method including the steps:
providing a layer of a composite optical material having substantially uniform thickness, the composite optical material having a three dimensional arrangement of core particles distributed in a matrix, the refractive index of the material of the core particles being different to the refractive index of the material of the matrix, and the three dimensional arrangement being capable of having a periodicity such that, when a surface of the material is illuminated with white light, the composite material exhibits structural colour,
mounting the layer of composite optical material with respect to a substrate to form the composite optical device, wherein the local stiffness of the substrate is different at different positions of the substrate, so that on mechanical deformation of the composite optical device, the substrate is deformed to a different extent at different positions of the substrate and the layer of composite optical material is correspondingly deformed to a different extent at different positions of the layer of composite optical material, thereby providing local variation in the structural colour response of the layer of composite optical material on mechanical deformation of the composite optical device.

In a third preferred aspect, the present invention provides a composite optical material obtained by, or obtainable by, a method according to the second aspect.

In a fourth preferred aspect, the present invention provides a use of a composite optical device, the composite optical device comprising a layer of a composite optical material mounted with respect to a substrate,
wherein the layer of composite optical material has substantially uniform thickness, and the composite optical material has a three dimensional arrangement of core particles distributed in a matrix, the refractive index of the material of the core particles being different to the refractive index of the material of the matrix,
and wherein the local stiffness of the substrate is different at different positions of the substrate,
   the use comprising the steps:
mechanically deforming the composite optical device so that the substrate is deformed to a different extent at different positions of the substrate and the layer of composite optical material is correspondingly deformed to a different extent at different positions of the layer of composite optical material, thereby providing local variation of the periodicity of the three dimensional arrangement of core particles in the matrix; and
illuminating a surface of the mechanically deformed layer of composite optical material to reveal local variation of the structural colour response of the layer of composite optical material.

Illumination of the composite optical material may be with white light. Alternatively, illumination may be with coloured light of any combination of wavelengths, or with monochromatic light. Illumination with coloured light is of interest, for example, for on-off switching applications.

Preferred and/or optional features of the invention will now be set out. These are applicable singly or in any combination with any aspect of the invention, unless the context demands otherwise.

The layer of composite optical material may be mounted with respect to the substrate via one or more intervening layers. However, it is more preferred that the layer of composite optical material is bonded directly to the substrate. Suitable bonding may be via an adhesive, by welding, by stitching or by other suitable means. Direct bonding means that the variation in local deformation is transposed directly to the layer of composite optical material, allowing a sharper definition at the boundaries of the local variation in structural colour response.

The substrate is typically provided in the form of a sheet. The mechanical properties of the substrate typically dominate the mechanical properties of the composite optical device. For example, the elastic modulus (or volume average elastic modulus) of the material of the substrate is typically greater than (and preferably substantially greater than) the elastic modulus of the composite optical material. Furthermore, the volume average stiffness of the substrate is typically greater than (and preferably substantially greater than) the volume average stiffness of the composite optical material.

Variation in the local stiffness of the substrate may be provided in various ways. Broadly, the options can be categorised in two ways: structure-based variations and materials-based variations.

Suitable structure-based variations include variation of the local thickness of the substrate. In this case, the material of the substrate may be uniform across the substrate. The substrate may be thinned locally, in order that local deformation is larger locally than on average across the substrate. Alternatively, the substrate may be thickened locally, in order that local deformation is smaller locally than on average across the substrate.

A further structure-based variation is provided by one or more reinforcing members on the substrate. Suitable reinforcing members may be of different material to the material of the substrate. The reinforcing members may be bonded to the substrate. Where the substrate is a fabric substrate, reinforcement may be provided in the form of embroidery of the substrate.

It is noted here that it is possible (although not necessarily preferred) for the substrate to be formed of one or more additional layers of the composite optical material.

Suitable materials-based variations include variation of the local elastic modulus of the material of the substrate. In this case, it is possible (although not essential in all embodiments) for the substrate to have a substantially uniform thickness. This is advantageous because there is then no thickness variation which directly corresponds to the local variation in the structural colour response, making identification of a specific security feature in the device more difficult without mechanically deforming the device.

Variation in the local elastic modulus can be achieved by control of the cross-linking density in the substrate. Depending on the cross-linking mechanism used in a specific polymeric substrate material, control of the cross-linking density can be provided by pattering control of the cross-linking (e.g. UV cross linking, chemical cross-linking and/or thermal cross-linking).

The substrate itself may have a composite structure, in which a first layer of the substrate has a different stiffness and/or stiffness profile to a second layer of the substrate. For example, a first layer of the substrate may be continuous and flexible. A second layer of the substrate may comprise a stiff but discontinuous material, e.g. in the form of islands. The polymer opal layer may be formed on top of the second layer. This gives a particularly striking effect on bending of the composite optical device. Bending the device such that the second layer is under tension increases separation between the islands in the second layer. This provides a sharp local spatial change in the stress applied to the polymer opal and therefore provides a sharp spatial variation in structural colour response in the polymer opal.

In addition to the control of the local stiffness of the substrate, there may also be provided control of the local stiffness of the layer of composite optical material, at positions corresponding to the local stiffness variations in the substrate. The advantage of this is that the structural colour response may be enhanced. Furthermore, the sharpness of the interface between the different structural colour response regions of the layer of composite optical material may be increased, improving the user's perception of the effect of the variation in structural colour response. It is particularly preferred that the control of the local stiffness of the layer of composite optical material is achieved by control of the local elastic modulus of the layer of composite optical material. This can be provided by control of the cross-linking density in the layer of composite optical material. Depending on the cross-linking mechanism used in a the layer of composite optical material, control of the cross-linking density can be provided by pattering control of the cross-linking (e.g. UV cross linking, chemical cross-linking and/or thermal cross-linking). It should be noted that changes in stiffness for most materials impose corresponding changes in the thermal expansion coefficient, thereby providing formation of a temperature induced pattern.

The local variation in the structural colour response of the composite optical device preferably provides a recognisable pattern or an identifying image. For example, one or more alphanumeric characters may be provided. Alternatively, one or more pictograms may be provided. As will be understood, there is no particular limitation on the language or script of the characters that can be used.

The behaviour of the composite optical device can be selected according to requirement. For example, before mechanical deformation, the pattern or image may not be visible in the device. In this case, the pattern or image may only become visible on mechanical deformation of the device. Alternatively, before mechanical deformation, the pattern or image may be visible in the device. In this case, the pattern or image may reduce in contrast or disappear with respect to the remainder of the layer of composite optical material on mechanical deformation of the device. In another embodiment, the behaviour of the composite optical device may be selected to that one pattern disappears on mechanical deformation of the device while another pattern appears.

Various mechanical deformations are envisaged. However, the most straightforward mechanical deformations suitable for use with embodiments of the present invention are stretching (e.g. uniaxial stretching), compression and bending. Compression may be applied, for example with the device against a transparent window.

The device may deform elastically, returning to an initial configuration after deformation. In that case, preferably the local variation in structural colour response is reversible.

However, for some applications (e.g. for tamper indication devices), preferably the device does not return to an initial configuration after deformation. This preferably leaves a substantially irreversible local variation in structural colour visible in the layer of composite optical material. This can be achieved relatively easily. Furthermore, polymer opals typically become irreversibly grey coloured at a critical yield stress. The substrate can be engineered to ensure that the irreversible local variation occurs in a predictable place in the device.

The core particles are disposed in the composite optical material in an arrangement based on a three dimensional crystallographic close packed lattice. Preferably the core particles are disposed in the composite material in an arrangement based on a face centred cubic lattice. Preferably, a {111} plane (nominally the (111) plane) of the lattice is aligned substantially parallel to a major surface of the layer of composite optical material. Bragg reflection in polymer opals tends to be strongest for the most densely populated crystal planes. Therefore reflection is strongest from the {111} close packed planes.

The composite optical material is typically formed by shear processing of a precursor composite material. It has been found that suitable ordering of the core particles in the matrix can be obtained by repeated shearing back and forth along a shear processing direction. Such processing tends to produce a composite optical material in which a close packed direction is parallel to the shear processing direction.

Preferably, the core particles have a difference in refractive index compared with the matrix material, of at least 0.001, more preferably at least 0.01, still more preferably at least 0.1.

In some embodiments, in order to form the composite optical material, there is provided a population of core-shell particles. Each core-shell particle preferably comprises a core and a shell material surrounding the core. The population may take the form of granules. Preferably, the population is heated to a temperature at which the shell material is flexible and soft. The population is then preferably subjected to the action of a mechanical force to initiate three dimensionally periodic arrangement of the core particles in a matrix of the shell material. This mechanical force is preferably provided by an extrusion process. The result of the extrusion process is typically a ribbon of precursor composite material.

Preferably, the ribbon of precursor composite material is captured and held between first and second sandwiching layers. The resulting structure may then be rolled (or calendered or otherwise pressed) in order to cause the precursor composite material to flow further. In some embodiments (e.g. for films of thickness greater than about 200 μm), suitable structural colour can be achieved at this point in the process and further colour enhancement steps may not be necessary.

If a further colour enhancement step is needed or desired, the composite material is then preferably allowed to cool to a temperature at which the shell material is no longer soft. The resulting sandwich structure can then be subjected to further processing in order to provide the required degree of periodicity of the core particles in the matrix. Such a subsequent colour enhancement step is considered to be suitable for thin opal films (e.g. of thickness less than 200 μm) which are preferred in some embodiments of this invention.

Other processes can be used in place of extrusion. For example, the action of mechanical force may take place via one or more of: uniaxial pressing (e.g. forming a film or plate); injection-moulding; transfer moulding; co-extrusion; calendering; lamination; blowing; fibre-drawing; embossing; and nano-imprinting.

When the action of force takes place through uniaxial pressing, the precursor composite material is preferably in the form of a film or layer. Suitable films or layers can preferably also be produced by calendering, film blowing or flat-film extrusion.

When the precursor composite material is produced by injection moulding, it is particularly preferred for the demoulding not to take place until after the mould with moulding inside has cooled. When carried out in industry, it is advantageous to employ moulds having a large cooling-channel cross section since the cooling can then take place in a relatively short time. The mould may advantageously be heated before the injection operation.

The processes set out above rely on mechanical shearing of the film in order to produce the required periodicity in the film. However, other processes are also possible. For example, a dispersion (e.g. an aqueous dispersion) of the core-shell particles can be dried in order to form the required film. Because of the absence of shear, the orientation of the lattice is not so easy to obtain as in the processes discussed above. Typically, the (111) planes form the surface of the film, but for further orientation (closely packed strips of particles a discussed below for the shear processes) a directional, vertical drying is carried out as described in Jiang et al (1999) [Jiang, P.; Bertone, J. F.; Hwang, K. S.; Colvin, V. L. “Single-Crystal Colloidal Multilayers of Controlled Thickness” Chem. Mater. 1999, 11, 2132-2140] and Wohlleben (2007) [Wendel Wohlleben, Frank W. Bartels, Stephan Altmann, and Reinhold J. Leyrer “Mechano-Optical Octave-Tunable Elastic Colloidal Crystals Made from Core-Shell Polymer Beads with Self-Assembly Techniques” Langmuir 2007, 23, 2961-2969]. In this process, the film can be formed of polystyrene-polyethylacrylate core shell particles.

Preferably, the core particles have a substantially monodisperse size distribution. The size of the core particles depends on the intended wavelength(s) at which the composite optical material should provide the required optical effect(s). For example, it may be desirable for the core particles to have a mean particle diameter in the range from about 5 nm to about 2000 nm. More preferably, the core particles have a mean particle diameter in the region of about 50-500 nm, more preferably 100-500 nm. Still more preferably, the core particles have a mean particle diameter of at least 150 nm. The core particles may have a mean particle diameter of at most 400 nm, or at most 300 nm, or at most 250 nm.

Preferably, the material of the core particles remains substantially rigid and substantially undeformed during the process. This can be achieved by: using a high crosslinking density in the core particles; and/or by using processing temperatures below the glass transition temperature (Tg) of the core material.

Thus, it is possible to use materials with a relatively low Tg for the core particles, provided that their degree of crosslinking is sufficient to avoid deformation of the core particles at the processing temperature using the method of the invention. A suitable degree of crosslinking may be, for example, 1% crosslinking density or higher. More preferably, the degree of crosslinking is 2% or more, more preferably about 10% crosslinking density.

Alternatively, although this is not necessarily preferred, inorganic core materials may be used.

Preferably, the shell of the core-shell particles is bonded to the core via an interlayer.

Suitable composite optical materials may be manufactured by suitable shearing of the precursor composite material, typically between first and second sandwiching layers. For example, one suitable approach is to deform the precursor composite material progressively and repeatedly over a hot edge. This is disclosed, for example, in WO 2011/004190, the contents of which are incorporated herein by reference in their entirety. Another suitable approach is to deform the precursor composite material by repeated curling, as disclosed in GB patent application 1100506.3, filed 12 Jan. 2011 and unpublished at the time of writing this disclosure, the contents of which are incorporated herein by reference in their entirety.

It is considered that the ordering of the core particles in the precursor composite material begins preferentially at the interfaces between the precursor composite material and the sandwiching layers. During the process, it is considered that the ordering then extends inwards into the precursor composite material. Therefore, at large thickness values, precise ordering of the material at the centre of the structure may not be achievable. However, for such large thickness values, this may not be a problem because there will be very many ordered layers nearer the interfaces with the sandwiching layers. Preferably, the thickness of the composite optical material is at most 1 mm. More preferably, the thickness of the composite optical material is at most 0.5 mm, or at most 0.4 mm, or at most 0.3 mm. The thickness of the composite optical material is preferably at least 10 μm, since thinner structures may not have sufficient mechanical integrity for practical uses and may not provide sufficiently strong reflections in order to exhibit a significant structural colour effect. More preferably, the thickness of the composite optical material is at least 20 μm, or at least 30 μm, or at least 40 μm, or at least 50 μm, or at least 60 μm, or at least 70 μm, or at least 80 μm. A thickness of about 100 μm has been found to be suitable, for example.

The composite optical material and/or the precursor composite material may comprise auxiliaries and/or additives. These can serve in order to provide desired properties of the body. Examples of auxiliaries and/or additives of this type are antioxidants, UV stabilisers, biocides, plasticisers, film-formation auxiliaries, flow-control agents, fillers, melting assistants, adhesives, release agents, application auxiliaries, demoulding auxiliaries and viscosity modifiers, for example thickeners, pigments and fillers.

Preferably, one or more species of nanoparticles is included in the matrix material, in addition to the cores of the core-shell particles. These particles are selected with respect to their particle size in such a way that they fit into the cavities of the packing (e.g. sphere packing) of the core particles and thus cause only little change in the arrangement of the core particles. Through specific selection of corresponding materials and/or the particle size, it is firstly possible to modify the optical effects of the composite optical material, for example to increase its intensity. Secondly, it is possible through incorporation of suitable “quantum dots”, to functionalise the matrix. Preferred materials are inorganic nanoparticles, in particular carbon nanoparticles (e.g. carbon nanotubes), nanoparticles of metals or of II-VI or III-V semiconductors or of materials which influence the magnetic/electrical (electronic) properties of the materials. Examples of further preferred nanoparticles are noble metals, such as silver, gold and platinum, semiconductors or insulators, such as zinc chalcogenides and cadmium chalcogenides, oxides, such as haematite, magnetite or perovskite, or metal nitrides, for example gallium nitride, or mixed phases of these materials. Furthermore, the matrix material can include one or more dyes. A suitable dye may be fluorescent.

Preferably, the nanoparticles have an average particle size of 50 nm or less. The nanoparticles may have an average particle size of at least 5 nm. An average particle size in the range 10-50 nm (e.g. about 20 nm) has been found to give suitable results. Preferably, the proportion by weight of the nanoparticles in the composite is less than 1%, more preferably less than 0.5%, less than 0.1% and still more preferably less than 0.01%. The nanoparticles preferably are distributed uniformly in the matrix material.

Preferably, the interlayer is a layer of crosslinked or at least partially crosslinked polymers. The crosslinking of the interlayer here can take place via free radicals, for example induced by UV irradiation, or preferably via di- or oligofunctional monomers. The crosslinked or partially crosslinked interlayer provides reactive functions for the grafting of polymer chains of the shell polymer. It is preferred to use the same functional groups for crosslinking of the interlayer and for the grafting of the shell polymer. Preferred interlayers in this embodiment comprise from 0.01 to 100% by weight, particularly preferably from 0.25 to 10% by weight, of di- or oligofunctional monomers. Grafting can also be obtained by using di- or oligofunctional monomers in the core, but this is not preferred as more of the di- or oligofunctional monomer is needed. Suitable di- or oligofunctional monomers are, in particular, isoprene and allyl methacrylate (ALMA). The interlayer preferably has a thickness in the range from 10 to 20 nm. Thicker interlayer materials may be possible.

Preferably the shell is formed of a thermoplastic or elastomeric polymer. Since the shell essentially determines the material properties and processing conditions of the core-shell particles, the person skilled in the art will select the shell material in accordance with the usual considerations in polymer technology, but with particular attention to the requirement that there should be a significant refractive index difference compared with the core material, in order to provide structural colour.

The core particles are preferably spherical, or substantially spherical, in shape. Preferably, the distribution of the diameter of the core particles is substantially monodisperse, e.g. with a standard deviation of 20% or less, more preferably 10% or less, more preferably 5% or less, still more preferably 3% or less.

It can be advantageous for the core:shell volume ratio to be in the range from 2:1 to 1:5, preferably in the range from 3:2 to 1:3 and particularly preferably in the region below 1.2:1. In specific embodiments of the present invention, it is even preferred for the core:shell volume ratio to be less than 1:1, to assist the melt processing in terms of allowing the cores to move in the matrix. Where an interlayer is provided, preferably the volume of core and interlayer present in the material is less than 50 vol %, e.g. about 45 vol %.

Further optional features of the invention are set out below.

### BRIEF DESCRIPTION OF THE DRAWINGS

Preferred embodiments of the invention will be set out by way of example with reference to the drawings, in which:

FIG. 1 shows a schematic cross sectional view of an embodiment of the invention.

FIG. 2 shows a schematic cross sectional view of another embodiment of the invention.

FIG. 3 shows a schematic cross sectional view of another embodiment of the invention.

FIG. 4 shows a schematic cross sectional view of another embodiment of the invention.

FIG. 5 shows a schematic cross sectional view of a process for manufacturing an embodiment of the invention.

FIG. 6 shows a schematic cross sectional view of a testing procedure applied to an embodiment of the invention.

FIGS. 7 to 10 show schematic plan views of the device of FIG. 6 subjected to different tensile strains. FIGS. 11 to 14 show experimentally-determined greyscale value plots for devices according to FIGS. 7 to 10 respectively.

FIG. 15 shows a schematic cross sectional view of an embodiment of the invention being subjected to tensile strain.

FIG. 16 shows a schematic cross sectional view of an embodiment of the invention being subjected to bending strain.

### DETAILED DESCRIPTION OF THE PREFERRED EMBODIMENTS FURTHER OPTIONAL FEATURES OF THE INVENTION

The entire content of each the documents referred to in any section of this disclosure is hereby incorporated by reference.

The rubber-like opal films disclosed in U.S. Pat. No. 6,337,131 (equivalent to EP-A-955323) and US 2004/0253443 (equivalent to WO03025035 and EP-B-1425322) were found to be suitable for use as the composite optical material in preferred embodiments of the invention. They consist of monodisperse polymer core particles embedded and crystallized inside a matrix of soft polymer which renders the so-called “opal films” or “rubbery opals” easily deformable. Their deformation under strain is uniform unless the special measures described below are employed in order to provide local variation in the structural colour response under strain. The melt-processing technique disclosed in US 2004/0253443 is especially suited to yield large area samples with well-known orientation of the colloidal crystal lattice.

In the simplest case this melt-processing is carried out by pressing a molten mass of core-interlayer-shell particles between two flat metal sheets covered with a protective foil to prevent sticking. The melt flows outwards and the particles crystallize forming a colloidal crystalline opal film disc while the polymer shells coalesce to form a continuous polymer matrix. The synthesis of the core-interlayer-shell beads and the preparation of the opal disks has been described in detail in Ruhl and Hellmann (2001) and Ruhl et al (2003) [T. Ruhl, P. Spahn, G. P. Hellmann “Artificial opals prepared by melt compression” Polymer 2003, 44, 7625-7634].

To achieve a high strain of greater than 10% (and preferably much greater than 10%) without cracking, the shell polymer of the beads which forms the matrix of the opal films should have a Glass Transition Temperature Tg which is lower than the temperature of the film during the deformation. For a given Tg, e.g. Tg>60° C. for opal films which are solid at room temperature, the temperature during the deformation should be adjusted appropriately. If the temperature during the deformation is fixed, e.g. ambient temperature (typically taken to be 23° C.), a suitable composition of the shell polymer can be chosen to adjust Tg. The adjustment of Tg by a variation of the polymer composition is well known to the specialist and industrial standard. For emulsion polymerization, it is described e.g. in “Waβrige Polymerdispersionen: Synthese, Eigenschaften, Anwendungen” Dieter Distler, Weinheim; New York; Chichester; Brisbane; Singapore; Toronto: Wiley-VCH, 1999. Emulsion polymerization is a suitable technique for the formation of the core-shell particles.

Many acrylic, methacrylic, styrenic, vinyl and other monomers are available for the emulsion polymerization. The present inventors have found that comonomers of ethyl acrylate and iso-butyl methacrylate are especially appropriate as shell polymers. Both react quickly and completely during the emulsion polymerization. The ethylacrylate lowers the Tg and yields soft, elastic polymers. Poly ethylacrylate has a refractive index of n=1.47. The iso-butyl methacrylate increases the Tg while the refractive index of the copolymer remains low. Poly-iso-butylmethacrylate has a refractive index of 1.45. Copolymers of ethylacrylate and iso-butylmethacrylate can be varied between soft and sticky, very elastic through tough and leatherlike to brittle.

The crystal lattice orientation inside the opal discs was determined by Pursiainen et al (2008) [O. L. J. Pursiainen, J. J. Bamberg, H. Winkler, B. Viel, P. Spahn, T. Ruhl “Shear-Induced Organization in Flexible Polymer Opals” Adv. Mater. 2008, 20, 1484-[1478] and by Ruhl et al (2004) [T. Ruhl, P. Spahn, H. Winkler, G. P. Hellmann “Large Area Monodomain Order in Colloidal Crystals” Macromol. Chem. Phys. 2004, 205, 1385-1393]. The main characteristics of the crystal lattice orientation are:

(a) The surface of the opal disc contains close packed beads

(b) Each radial sector can be seen as a single crystal of the fcc lattice

(c) The (111) planes of the fcc lattice run parallel to the surface

(d) Close packed lines of beads run radially along the surface

As mentioned above, an alternative route for the preparation of thin opal tapes by extrusion, calendering and an additional colour enhancement step has been disclosed in WO 2011/004190, the contents of which are incorporated herein by reference in their entirety. Another suitable approach is to deform the precursor composite material by repeated curling, as disclosed in GB patent application 1100506.3, filed 12 Jan. 2011 and unpublished at the time of writing this disclosure, the contents of which are incorporated herein by reference in their entirety. The shearing process in these disclosures does not provide radial flow of the precursor composite material. As such, the orientation of the fcc lattice is different compared with the simpler approach of pressing a molten mass of the material. In these disclosures, the (111) planes are still parallel to the film surface but the close packed lines of beads run along the length of the film (i.e. parallel to the shear processing direction).

A layer of the polymer opal is bonded to a substrate whose local stiffness is controlled in order to provide a specific image or pattern. The deformation characteristics of the resultant laminated device are typically dominated by the substrate, since the stiffness of the polymer opal layer is typically very low. Therefore any variation in the local deformation of the substrate is transmitted into the polymer opal layer, with the result that the local structural colour response of the polymer opal layer is affected.

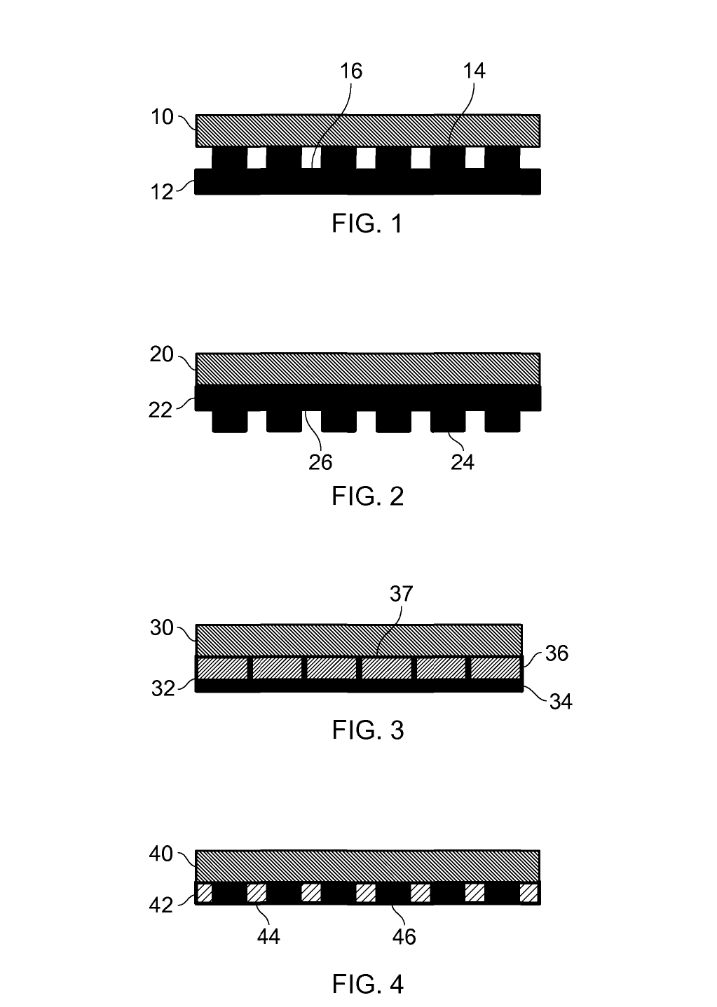

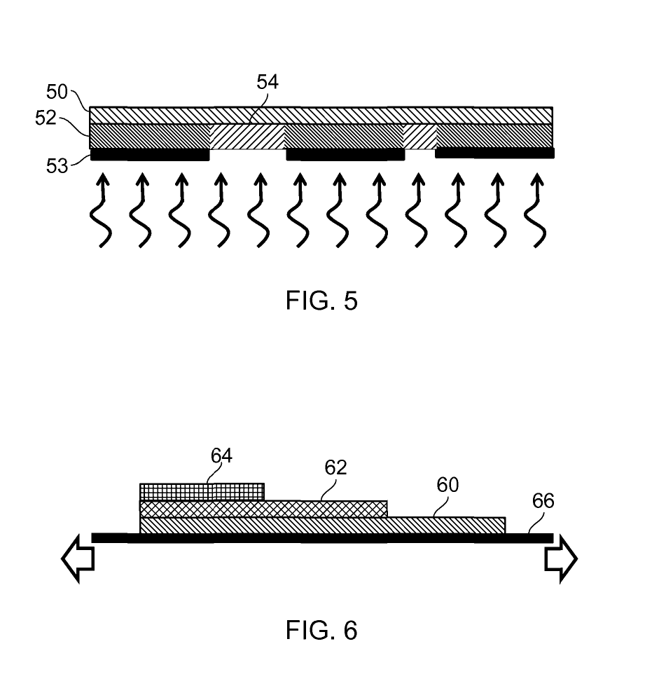

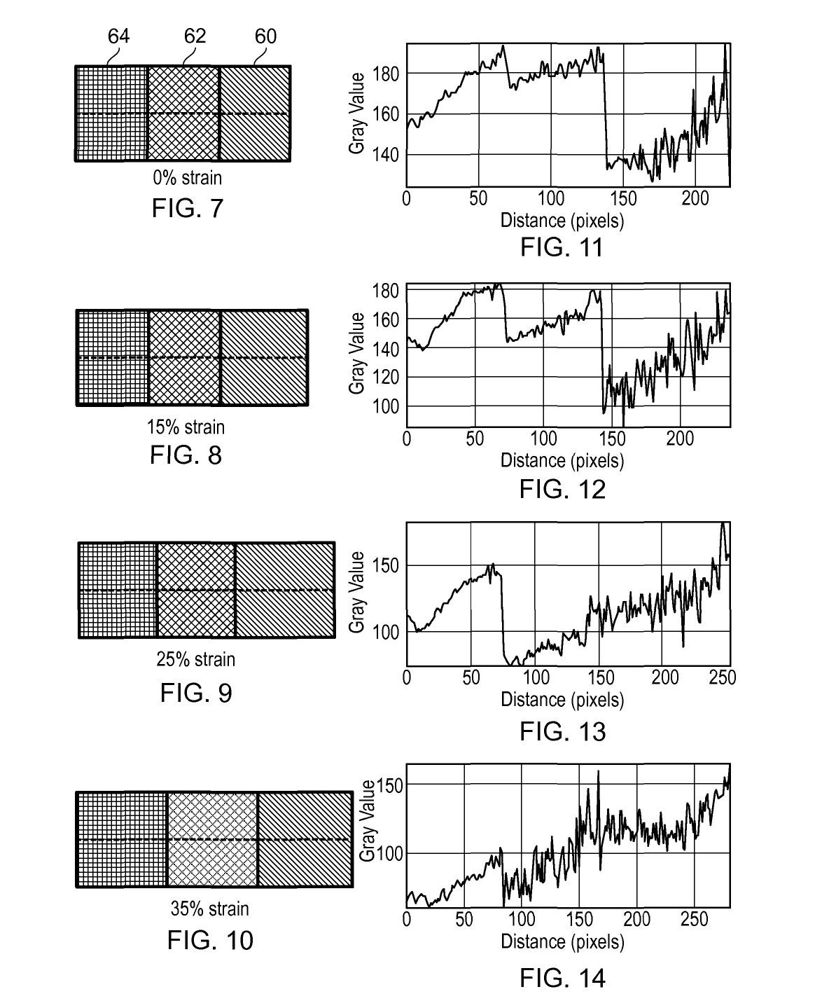

FIG. 1 shows a schematic cross sectional view of an optical device according to an embodiment of the invention. A polymer opal film 10 is provided on a substrate 12. The substrate 12 is formed of a moulded (e.g. embossed) polymeric film to provide the film with a regular variation in thickness. The polymer opal film 10 is bonded to the substrate only at the upstanding, thicker regions 14 of the substrate 12. The material of the substrate 12 has a higher elastic modulus than the material of the polymer opal film 10. Therefore the mechanical properties of the composite device are dominated by the substrate 12. On uniaxial strain of the composite device, the thicker regions 14 of the substrate deform less than the thinner regions 16 of the substrate. Correspondingly, the polymer opal film deforms locally more in the regions of the polymer opal film corresponding to the thinner regions 16 than the thicker regions 14. This leads to a variation in structural colour response in the polymer opal film.

FIG. 2 shows a schematic cross sectional view of another embodiment of the invention. This is similar to the embodiment of FIG. 1, except that the substrate 22 is inverted so that the polymer opal film 20 is bonded to a flat surface of the substrate 22. On uniaxial strain of the composite device, the thicker regions 24 of the substrate deform less than the thinner regions 26 of the substrate. Correspondingly, the polymer opal film deforms locally more in the regions of the polymer opal film corresponding to the thinner regions 26 than the thicker regions 24. This leads to a variation in structural colour response in the polymer opal film. However, the sharpness of the variation in in structural colour response in the polymer opal film is less than in the embodiment of FIG. 1.

FIG. 3 shows a schematic cross sectional view of another embodiment of the invention. In this embodiment, the substrate 32 has a first layer 34 and a second layer 36. First layer 34 is formed of a continuous layer of polymer material with a relatively low elastic modulus. Second layer 36 comprises an array of islands 37 of a relatively stiff material (relatively high elastic modulus) in a continuous matrix 38 of a relatively low elastic modulus material. On uniaxial strain of the composite device, the regions of the device corresponding to the islands 37 deform less than the remaining regions of the device. Correspondingly, the polymer opal film 30 deforms in a spatially non-uniform manner, leading to a variation in structural colour response in the polymer opal film.

FIG. 4 shows a schematic cross sectional view of another embodiment of the invention. In this embodiment, the substrate 42 is formed of a cross-linkable polymer. Island regions 44 of high cross linking density are formed in a matrix 46 of relatively low cross linking density. The result is that the island regions have a relatively high elastic modulus and the matric 46 has a relatively low elastic modulus. On uniaxial strain of the composite device, the regions of the device corresponding to the islands 44 deform less than the remaining regions of the device. Correspondingly, the polymer opal film 40 deforms in a spatially non-uniform manner, leading to a variation in structural colour response in the polymer opal film.

FIG. 5 shows a schematic cross sectional view of a process for manufacturing an embodiment of the invention. Polymer opal film 50 is formed on a substrate 52 is made of a cross-linkable polymer. Mask 53 is provided on the substrate 52. The masked substrate is exposed to UV radiation for a required period of time in order to promote cross linking at regions 54 of the substrate corresponding to openings in the mask. The result is a variation in cross-linking density in the substrate and a consequential variation in elastic modulus in the substrate, with the behaviour described with respect to FIG. 4.

FIG. 6 shows a schematic cross sectional view of a composite optical device comprising first 60, second 62 and third 64 polymer opal films bonded to each other in a stack. The lowermost polymer opal film is film 60, which in turn is bonded to a polymeric film substrate 66 (not a polymer opal film) of low elastic modulus. First 60, second 62 and third 64 polymer opal films have different areas. The result is that the stiffness of the resultant composite device varies across the device. During testing (reported below), the device is stretched uniaxially as shown by the arrows in FIG. 6.

FIGS. 7 to 10 show schematic plan views of the device of FIG. 6 subjected to different tensile strains. FIGS. 11 to 14 show greyscale value plots taken from photographic images through a red filter for the device as stretched according to FIGS. 7 to 10 respectively. As can be seen from FIGS. 11 to 14, as the device is stretched, the red structural colour displayed by the exposed part of the first polymer opal film 60 is gradually reduced (experiments showed that the colour became blue) while the colour from the exposed part of the second polymer opal film 62 and the third polymer opal film 64 is no changed significantly between FIGS. 11 and 12. However, on further stretching, as shown in FIG. 13, the second polymer opal film 62 begins to lose red structural colour (experiments showed that the colour became blue). On still further stretching, as shown in FIG. 14, the third polymer opal film 64 begins to lose red structural colour (experiments showed that the colour became blue).

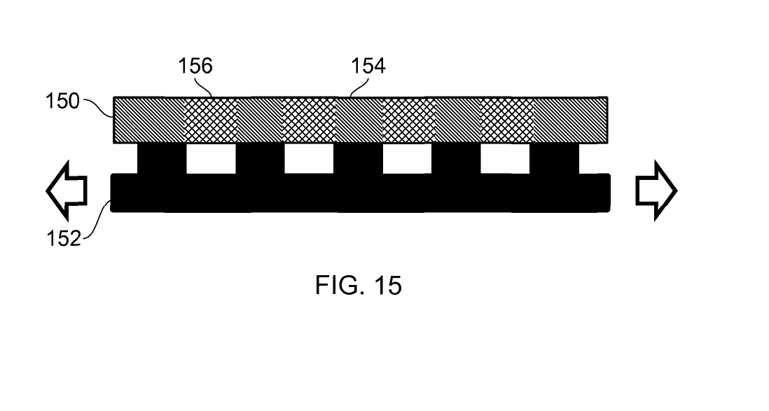

FIG. 15 shows a schematic cross sectional view of an embodiment of the invention corresponding to the embodiment of FIG. 1 being subjected to tensile strain, as indicated by the arrows. The variation in stiffness through the device, due to the structure of the substrate 152, leads to corresponding variations in the deformation in the polymer opal film 150. High deformation regions 156 exhibit a greater structural colour change response than low deformation regions 154.

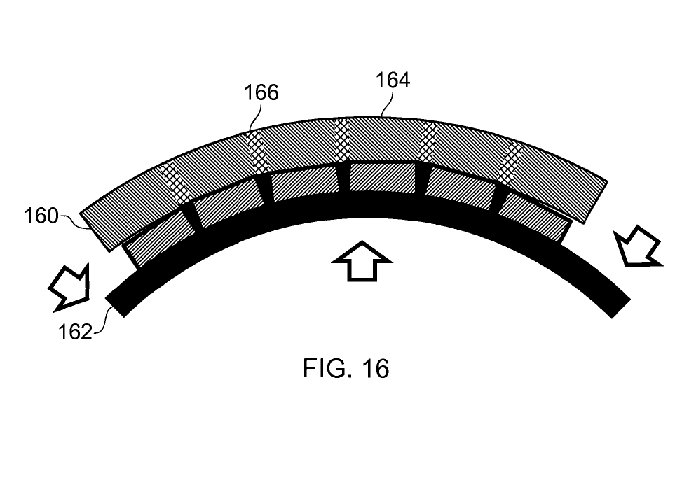

FIG. 16 shows a schematic cross sectional view of an embodiment of the invention corresponding to the embodiment of FIG. 3 being subjected to bending strain, as indicated by the arrows. The variation in stiffness through the device, due to the structure of the substrate 162, leads to corresponding variations in the deformation of the polymer opal film 160. High deformation regions 166 exhibit a greater structural colour change response than low deformation regions 164.

### EXPERIMENTAL

### Preparation of Monodisperse Core-Interlayer-Shell Polymer Heads

The beads produced here were similar to those described in US 2004/0253443.

A 10 L reactor with stirrer, condenser, argon inlet and heating mantle was heated to 75° C. and flushed with argon.

2.750 g sodium dodecylsulfate

2800.000 g demineralised water

36.000 g styrene

4.000 g butane dioldiacrylate

were premixed and fed into the reactor. The stirrer was adjusted to 250 rpm. The temperature of the mixture was monitored. At 65° C., three freshly prepared solutions were subsequently added:

0.360 g sodium disulfite in 5 g demineralised water

5.180 g sodium persulfate in 20 g demineralised water

0.360 g sodium disulfite in 5 g demineralised water

Cloudiness was observed after 10 min. After an additional 10 min, an emulsion consisting of

2.300 g sodium dodecylsulfate

4.000 g potassium hydroxide

2.200 g Dowfax2A1 (Dow Chemicals)

900.000 g demineralised water

700.000 g styrene

70.000 g butane dioldiacrylate

was fed dropwise at 10 mL/min. 30 min after the addition was finished, a freshly prepared solution of

0.250 g sodium persulfate in 5 g demineralised water

was added. After 15 min, a second emulsion consisting of

0.500 g sodium dodecylsulfate

2.100 g Dowfax 2A1

320.000 g demineralised water

250.000 g methyl methacrylate

30.000 g allyl methacrylate

was fed dropwise at 14 mL/min. 20 min after the addition was finished, a third emulsion consisting of

4.000 g sodium dodecylsulfate

2.000 g potassium hydroxide

1600.000 g demineralised water

1400.000 g ethylacrylate

was added dropwise at 18 mL/min. The synthesis was terminated 60 min after the last addition was finished. The latex was filtered through a 100 μm sieve and added dropwise into a mixture of 17 L methanol and 100 mL of concentrated aqueous solution of sodium chloride under stirring. The polymer coagulated and formed a precipitate which settled after the stirring was terminated. The clear supernant was decanted, the precipitate was mixed with 5 L demineralised water and subsequently filtered through a 100 micron sieve. The filter cake was dried for three days at 45° C. in a convective oven.
Preparation of Monodisperse Core-Interlayer-Shell Polymer Beads with Higher Tg

A 10 L reactor with stirrer, condenser, argon inlet and heating mantle was heated to 75° C. and flushed with argon.

2.750 g sodium dodecylsulfate

2800.000 g demineralised water

36.000 g styrene

4.000 g butane dioldiacrylate

were premixed and fed into the reactor. The stirrer was adjusted to 250 rpm. The temperature of the mixture was monitored. At 65° C., three freshly prepared solutions were subsequently added:

0.360 g sodium disulfite in 5 g demineralised water,

5.180 g sodium persulfate in 20 g demineralised water

0.360 g sodium disulfite in 5 g demineralised water

Cloudiness was observed after 10 min. After an additional 10 min, an emulsion consisting of

2.300 g sodium dodecylsulfate

4.000 g potassium hydroxide

2.200 g Dowfax2A1

900.000 g demineralised water

700.000 g styrene

70.000 g butane dioldiacrylate

was fed dropwise at 10 mL/min. 30 min after the addition was finished, a freshly prepared solution of

0.250 g sodium persulfate in 5 g demineralised water

was added. After 15 min, a second emulsion consisting of

0.500 g sodium dodecylsulfate

2.100 g Dowfax 2A1

320.000 g demineralised water

250.000 g ethylacrylate

30.000 g allyl methacrylate

was fed dropwise at 14 mL/min. 20 min after the addition was finished, a third emulsion consisting of

4.000 g sodium dodecylsulfate

2.000 g potassium hydroxide

1600.000 g demineralised water

404.7 g ethylacrylate

603.3 g isobutyl methacrylate

42 g hydroxyethyl methacrylate

was added dropwise at 18 mL/min. The synthesis was terminated 60 min after the last addition was finished. The latex was filtered through a 100 μm sieve and added dropwise into a mixture of 17 L methanol and 100 mL of concentrated aqueous solution of sodium chloride under stirring. The polymer coagulated and formed a precipitate which settled after the stirring was terminated. The clear supernant was decanted, the precipitate was mixed with 5 L demineralised water and subsequently filtered through a 100 micron sieve. The filter cake was dried for three days at 45° C. in a convective oven.
Preparation of Monodisperse Core-Interlayer-Shell Polymer Beads with Chemical Functionality for the Crosslinking with Polyisocyanates

A 10 L reactor with stirrer, condenser, argon inlet and heating mantle was heated to 75° C. and flushed with argon.

2.750 g sodium dodecylsulfate

2800.000 g demineralised water

36.000 g styrene

4.000 g butane dioldiacrylate

were premixed and fed into the reactor. The stirrer was adjusted to 250 rpm. The temperature of the mixture was monitored. At 65° C., three freshly prepared solutions were subsequently added:

0.360 g sodium disulfite in 5 g demineralised water

5.180 g sodium persulfate in 20 g demineralised water

0.360 g sodium disulfite in 5 g demineralised water

Cloudiness was observed after 10 min. After additional 10 min, an emulsion consisting of

2.300 g sodium dodecylsulfate

4.000 g potassium hydroxide

2.200 g Dowfax2A1

900.000 g demineralised water

700.000 g styrene

70.000 g butane dioldiacrylate

was fed dropwise at 10 mL/min. 30 min after the addition was finished, a freshly prepared solution of

0.250 g sodium persulfate in 5 g demineralised water

was added. After 15 min, a second emulsion consisting of

0.500 g sodium dodecylsulfate

2.100 g Dowfax 2A1

320.000 g demineralised water

250.000 g ethylacrylate

30.000 g allyl methacrylate

was fed dropwise at 14 mL/min. 20 min after the addition was finished, a third emulsion consisting of

4.000 g sodium dodecylsulfate

2.000 g potassium hydroxide

1600.000 g demineralised water

1358.000 g ethylacrylate

42 g hydroxyethylmethacrylate

was added dropwise at 18 mL/min. The synthesis was terminated 60 min after the last addition was finished. The latex was filtered through a 100 μm sieve and added dropwise into a mixture of 17 L methanol and 100 mL of concentrated aqueous solution of sodium chloride under stirring. The polymer coagulated and formed a precipitate which settled after the stirring was terminated. The clear supernant was decanted, the precipitate was mixed with 5 L demineralised water and subsequently filtered through a 100 micron sieve. The filter cake was dried for three days at 45° C. in a convective oven
Preparation of Polymer Compounds with Additives for the Melt-Processing

100 g of polymer was mixed with 1 g of Licolub FA1 (Clariant) and 0.05 g Special Black 4 (Evonik) at 140° C. and 100 rpm in an twin-screw DSM Xplore μ5 microextruder. The material was passed 4 times through the extruder.

Preparation of a Compound of CS354 for the Melt Processing with a Polyisocyanate Crosslinker

100 g of polymer was mixed with 1% Licolub FA1 (Clariant), 3% Crelan UI (BayerMaterialScience) and 0.05 g Special Black 4 (Evonik) in an twin-screw DSM Xplore μ5 microextruder at 120° C. and 100 rpm. The material was passed 4 times through the extruder.

Preparation of a Compound of CS330 for the Melt Processing with Photoinitiator for Additional Photocrosslinking

100 g of polymer was mixed with 1% Licolub FA1 (Clariant), 2% benzophenone (Sigma-Aldrich) and 0.05 g Special Black 4 (Evonik) in an twin-screw DSM Xplore μ5 microextruder at 120° C. and 100 rpm. The material was passed 4 times through the extruder.

### Preparation of Opal Disks by Pressing

6 g of polymer compound was heated on a hotplate set to 150° C. The softened polymer mass was placed between two PET foils and two polished, high-gloss ironless steel sheets and pressed in a Collin press at 150° C. and 130 bar hydraulic pressure for 3 minutes.

The embodiments set out above have been described by way of example. On reading this disclosure, modifications of these embodiments, further embodiments and modifications thereof will be apparent to the skilled person and as such are within the scope of the present invention.

1. A composite optical device in which a layer of a composite optical material is mounted with respect to a substrate, the layer of composite optical material having substantially uniform thickness, and wherein the composite optical material has a three dimensional arrangement of core particles distributed in a matrix, the refractive index of the material of the core particles being different to the refractive index of the material of the matrix and the three dimensional arrangement being capable of having a periodicity such that, when a surface of the material is illuminated with white light, the composite material exhibits structural colour,
wherein the local stiffness of the substrate is different at different positions of the substrate, so that on mechanical deformation of the composite optical device, the substrate is deformed to a different extent at different positions of the substrate and the layer of composite optical material is correspondingly deformed to a different extent at different positions of the layer of composite optical material, thereby providing local variation in the structural colour response of the layer of composite optical material on mechanical deformation of the composite optical device.

2. The composite optical device according to claim 1 wherein the layer of composite optical material is bonded directly to the substrate.

3. The composite optical device according to claim 1 wherein at least one of the elastic modulus and the volume average elastic modulus of the material of the substrate is greater than the elastic modulus of the composite optical material.

4. The composite optical device according to claim 1 wherein the volume average stiffness of the substrate is typically greater than the volume average stiffness of the composite optical material.

5. The composite optical device according to claim 1 wherein there is provided variation of the local thickness of the substrate.

6. The composite optical device according to claim 1 wherein one or more reinforcing members are provided on the substrate.

7. The composite optical device according to claim 1 wherein the substrate is a fabric substrate and local reinforcement is provided by embroidering.

8. The composite optical device according to claim 1 wherein there is provided variation of the local elastic modulus of the material of the substrate.

9. The composite optical device according to claim 8 wherein the substrate has a substantially uniform thickness.

10. The composite optical device according to claim 8 wherein variation in the local elastic modulus is provided by control of the cross-linking density in the substrate.

11. The composite optical device according to claim 8 wherein there is also provided control of the local stiffness of the layer of composite optical material, at positions corresponding to the local stiffness variations in the substrate.

12. The composite optical device according to claim 11 wherein control of the local stiffness of the layer of composite optical material is achieved by control of the local elastic modulus of the layer of composite optical material by control of the cross-linking density in the layer of composite optical material.

13. The composite optical device according to claim 1 wherein the local variation in the structural colour response of the composite optical device provides a recognisable pattern or an identifying image.

14. A method for manufacturing a composite optical device, the method including the steps:
providing a layer of a composite optical material having substantially uniform thickness, the composite optical material having a three dimensional arrangement of core particles distributed in a matrix, the refractive index of the material of the core particles being different to the refractive index of the material of the matrix, and the three dimensional arrangement being capable of having a periodicity such that, when a surface of the material is illuminated with white light, the composite material exhibits structural colour,
mounting the layer of composite optical material with respect to a substrate to form the composite optical device, wherein the local stiffness of the substrate is different at different positions of the substrate, so that on mechanical deformation of the composite optical device, the substrate is deformed to a different extent at different positions of the substrate and the layer of composite optical material is correspondingly deformed to a different extent at different positions of the layer of composite optical material, thereby providing local variation in the structural colour response of the layer of composite optical material on mechanical deformation of the composite optical device.

15. A method of using a composite optical device, the composite optical device comprising a layer of a composite optical material mounted with respect to a substrate,
wherein the layer of composite optical material has substantially uniform thickness, and the composite optical material has a three dimensional arrangement of core particles distributed in a matrix, the refractive index of the material of the core particles being different to the refractive index of the material of the matrix,
and wherein the local stiffness of the substrate is different at different positions of the substrate,
the method comprising the steps:
mechanically deforming the composite optical device so that the substrate is deformed to a different extent at different positions of the substrate and the layer of composite optical material is correspondingly deformed to a different extent at different positions of the layer of composite optical material, thereby providing local variation of the periodicity of the three dimensional arrangement of core particles in the matrix; and
illuminating a surface of the mechanically deformed layer of composite optical material to reveal local variation of the structural colour response of the layer of composite optical material.

16. The method according to claim 15 wherein the local variation in the structural colour response of the composite optical device provides a recognisable pattern or an identifying image.

17. The method according to claim 16 wherein, before mechanical deformation, the pattern or image is not visible in the device, the pattern or image only becoming visible on mechanical deformation of the device.

18. The method according to claim 16 wherein, before mechanical deformation, the pattern or image is visible in the device, the pattern or image reducing in contrast or disappearing with respect to the remainder of the layer of composite optical material on mechanical deformation of the device.

19. The method according to claim 15, wherein the mechanical deformation is at least one of stretching and bending.

20. The method according to claim 15, wherein the device deforms elastically, returning to an initial configuration after deformation, so that the local variation in structural colour response is substantially reversible.

21. The method according to claim 15, wherein the device does not return to an initial configuration after deformation, so that there is a substantially irreversible local variation in structural colour visible in the layer of composite optical material.
